(19) United States
(12) Patent Application Publication
(10) Pub. No.: US 2009/0178555 A1
(43) Pub. Date: Jul. 16, 2009

(54) Pressure in line degassing process in water treatment

(76) Inventors: George J. Crits, Ardmore, PA (US); William J. Runyan, West Chester, PA (US)

Correspondence Address: William J. Runyan, 24 Hagerty Blvd., Suite 9, West Chester, PA, 19382, US

(21) Appl. No.: 12/008,665

(22) Filed: Jan. 14, 2008

(51) Int. Cl. C02F 1/20; B01D 46/46

(52) U.S. Cl. 95/24; 95/259; 210/664; 210/750

(57) ABSTRACT

When water sprays into an empty tank or into the freeboard of filters, considerable flashing occurs to release about 50 to 80% of carbon dioxide, hydrogen sulfide, and other gases. The injection of air with the water enhances this degasification and produces a partial drained tank, in which it is required for the spraying or flashing to occur. When the water level reaches a low point, a switch signals for the vent to be opened and the air is stopped. But the inlet water continues to fill the tank and to displace the gasses through the vent. When the water reaches the vent, a high level switch closes the vent. Air injection starts again to repeat the cycle. Alternately, the injection of air with the influent water into a partially drained tank with a level controller and venting also effects this degasification.

### BRIEF DESCRIPTION OF THE INVENTION

Air is injected to the influent water spraying into filters or ion exchange units and tanks to cause degasification of dissolved carbon dioxide, methane, hydrogen sulfide. The freeboard of these tanks is purposely partially emptied to allow for the gases to be flashed into this space. Then the gases are displaced or removed from this space through the vent by re-filling the tank with the influent water. Simple drain & fill controls are utilized to perform this cyclic action.

### BACKGROUND OF THE INVENTION

Removal of gasses such as carbon dioxide (CO2) and Hydrogen sulfide (H2S) from water in the prior art requires degassers or decarbonators systems that include: A tall external degassing tower, blower for air injection, tank or sump for collection of the degassed water, level controls, and a pump for forwarding the degassed water. This array of equipment involves a large capital expense and more important there would be more floor space, real estate, and a higher head room required. This invention requires no degassing tower and no additional floor space. Also this invention may be back fitted or added to an existing system.

### BRIEF SUMMARY OF THE INVENTION

When water sprays into an empty tank, considerable flashing occurs to release about 50 to 80% of carbon dioxide gas and other gases are also released. The injection of air with the water enhances this degasification and in this present invention a partial empty tank is obtained when air is introduced causing the draining of the water from the freeboard. This space or freeboard in the tank is required for the spraying or flashing to occur. When the water level reaches a low level, a switch may or may not stop the air injection, but the water continues, and the vent is opened to refill the tank and displacing the gasses to the vent. When the water reaches the vent, a second switch closes the vent and the air injection is resumed if it was stop. This cyclic operation of filling and emptying of the freeboard is the main requirement of the invention. The removal of CO2, methane, hydrogen sulfide or other gasses may be accomplished by this novel invention, an in-expensive process. The degassing may also be effected by controlling the water level to the mid point of the freeboard, with injecting the air with the influent water and venting the gasses continuously with little or no cyclic action.

### BRIEF DESCRIPTION OF THE DRAWING

FIG. 1 shows a typical tank in which a bed 2 of filter media or ion exchange resin is installed. Above this bed, a space or freeboard 3 is required for this invention to be practiced. This freeboard height should be 60 to 100% of the bed depth. In the first step, air is injected at 4 or 5 into the inlet water. When the water: level reaches a low point 6, a level switch activates and may or may not stop the air injection and opens the vent at 7, and this starts the second step, with the filling of the tank with water. When the water level reaches high level switch 8, this signals for the vent to close and air injection to start again as in the first step. The cycle repeats. Effluent valve 9 or 10 either must be closed or set to restrict the effluent flow during the filling in second step. Air may be injected from compressed air supply at 5. Or alternately, air may be introduced at 4 by opening valve 11 supplying water to the eductor 12. A bypass valve 13 around the normal vent valve is utilized when less venting is desired. The inlet water distributor 14 is of conventional design for introducing water to the tank. A water level controller 15 may be provided at about the mid point of the freeboard of the tank for more continuous operation.

### DETAILED DESCRIPTION OF THE INVENTION

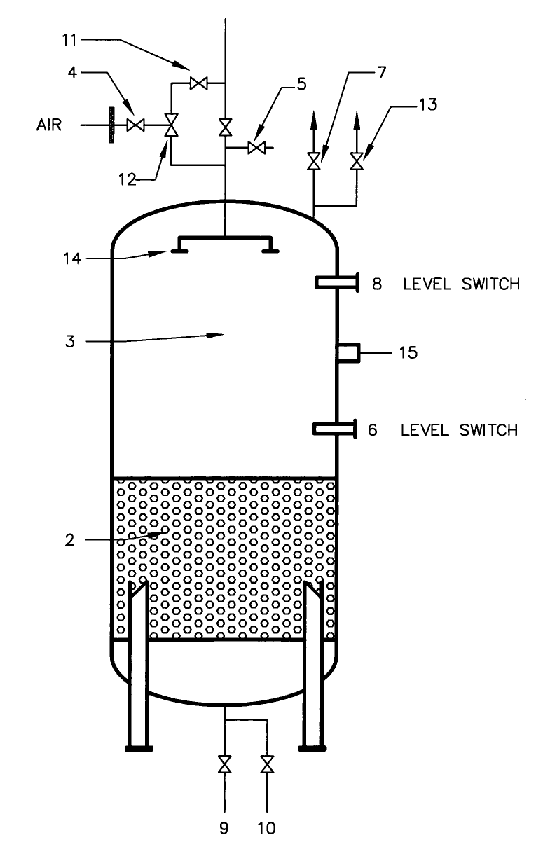

When water sprays into an empty tank, considerable flashing occurs to release about 60% of carbon dioxide gas and other gases are also released. The injection of air with the water enhances this degasification and air injection with the inlet water makes for more vigorous degassing effect when introduced into the freeboard 2, FIG. 1, of an operating filter or anion unit. First step, air is injected with the influent water and continued until the water level in the freeboard of the tank drops to a few inches above the bed, at which time a low level switch 6, opens the vent and the air injection at valve 4 or 5 may or may not be stopped depending on the hydrostatic or back pressures. This step with the air injection serves two purposes: First to start draining water from the freeboard to make a space and secondly to spray inlet water with air into this freeboard space to effect the degassing. In the second step, the vent valve 7 opens, effluent valve 9 closes, and the influent water with or without air continues and thus filling the tank. To continue the air injection in this second step depends on the parameters involved but would be desirable if possible. The air and gasses in the freeboard are displaced by the rising water in the freeboard, and removed through the vent 7. At this step the effluent valve 9 may have to be closed or set to a lower flow bypass valve 10 opened to restrict the draining or the service flow to allow for the filling of the freeboard above the bed. When the water level reaches the vent, a flow switch or a second level switch 8 closes the vent 7. When the vent is closed, the air injection with the influent water is started again, repeating the first step again. The cycle repeats and thus the cyclic filling and emptying of the water in the freeboard of the tank allows the degasification process to take place.

Another mode of operation in this application is continuous venting: The vent may be set to a small opening with perhaps a small bypass valve 13 and the injection of water and air continued with the level of water being preferably at mid point or lower in the freeboard. The small amount of vented air with the purge of gasses may allow one to continue with less frequent cycling. The controls are still required to open the vent to allow the water level to rise to the vent level. And the water low level switch is required to control when the water level reaches this point as outlined above.

In another mode of operation it is proposed that a level controller 15 be used to hold the water level in the freeboard to about 30 to 50% of the bed depth and inject air with the water along with the venting to make for a more continuous degassing operation or without or less cyclic action.

When this is performed in an anion tank following a hydrogen cation unit, the removal of Carbon dioxide (CO2) and Hydrogen sulfide (H2S) gasses are more favorably done due to acidity of the influent cation water. CO2 and H2S will be removed at 60% or more. The CO2 & H2S anion loading would thereby be reduced to make for longer running service time in the anion ion exchange unit: the main object of this degassing process.

Of course as with external conventional degassifiers/decarbonators, CO2 content should be more than 50 ppm to warrant this “pressure degassing” feature to be added.

In neutral pH water, the removal of CO2 may be about 50% or more. With methane gas, removals would be at about 50%. With H2S in neutral water, the removal is much less and depends on the pH of the water: the lower the pH, the more H2S is flashed and degassed. Thus in filter and anion exchange applications, acid may be fed to the influent water to lower the pH that is favored by H2S removal.

To enable the tank to fill with water again with the vent open, the effluent valve 9 may have to be restricted unless a hydraulic back pressure exists to reduce the effluent flow so that water level in the freeboard rises. Otherwise if some treated water is required during the filling period, the main effluent valve 9 will be closed and a smaller bypass effluent valve 10 may be opened to provide reduce effluent flow and to create a back-pressure which is required for the filling and degasification process. Other wise, the service flow may be interrupted during the filling step. In which case, service flow rates may be selected at higher flows (or the tank sized larger) to compensate for these stoppages. In any event the service flow will be interrupted or reduced in a cyclic manner, which in ion exchange and activated carbon filters is not a problem. In filter applications, the interruption should be smooth to avoid turbidity unloading if hydraulic shocks should occur.

Air injection may be effected in two ways: Use of a water eductor 12 sucking air from the atmosphere. In which case, an air filter at the suction point may be required in dusty areas. This eductor may be in line or in a bypass line. A small control valve 4 is required at the suction point. The other option is to inject air from a compressed air supply. A small control valve 5 is required here.

Air quantity required ranges from 0.1 to 0.5 CFM per gpm and but has to be adjusted to limit the cycle or draining time to a reasonable duration. This is generally determined at startup service time and is adjusted from time to time.

Another application for this process is in iron removal by adding air to the influent water in iron removal filters. This will not only vent the carbon dioxide but will oxidize and precipitate the dissolved iron in well water so that it can be removed by filtration. In this case, the air may be injected into the piping some distance ahead of the filter to allow for the oxidation or reaction time. Addition of lime, copper or permanganate may also be required to catalyze and speed this reaction to more completion.

With gravity filters where the freeboard of these are normally open, the addition of air with the influent water to enhance the degasification is also benefited by this process.

The inlet water distributor 14 may be of conventional design but to enhance the degassing, the orifices or splash plates should be small, and a large number of them, with exiting water velocities in the range of 3 to 6 ft./sec. Also it must be designed with symmetrical layout of the openings or orifices to introduce or lay down the water without undue splashing and disruption of the bed when the water level is low.

What is claimed:

1. We claim, in the process of degassing in line with pressure filters, the cyclic de-gassing process with first step, of addition of air with the influent water in filters to cause degasification with the releasing of carbon dioxide, methane, or hydrogen sulfide or other dissolved gasses into the freeboard space of the filter and simultaneously draining water from the freeboard to create the free space in which the released gasses will accumulate and in a second step, displacing the gasses through the vent by filling with influent water, and repeating of these steps will effect degasification.

2. In the process of degassing in line with pressure filters, the cyclic de-gassing process as in claim 1, wherein carbon dioxide or hydrogen sulfide is degassed and removed in anion or other ion exchange units, to reduce loading of the exchange material and thus allow for longer running service time.

3. In the process of degassing in line with pressure or gravity operated filters, the cyclic de-gassing process as in claim 1, wherein dissolved hydrogen sulfide, free chlorine, or other gas is degassed and removed in activated carbon filters to reduce loading of the carbon material and thus allow for longer running service time.

4. In the process of degassing in line pressure filters, the cyclic degassing process as claimed in claim 1, wherein carbon dioxide is removed and dissolved iron is oxidized to facilitate filtration in iron removal filters.

5. In the process of degassing in line pressure filters, where a level controller is utilized to maintain a proper water level in the freeboard of the tank along with continuous air injection and venting to remove the gasses with little or no cyclic process.
